(19) United States
(12) Patent Application Publication
(10) Pub. No.: US 2021/0333215 A1
(43) Pub. Date: Oct. 28, 2021

(54) APPARATUS AND METHOD FOR DETERMINATION OF FLUID-SPECIFIC PARAMETERS AND/OR COMPONENTS

(71) Applicant: SAFECHEM Europe GmbH, Duesseldorf (DE)

(72) Inventors: Dieter LUKOWSKI, Geldern (DE); Camille VICIER, Duesseldorf (DE)

(73) Assignee: SAFECHEM Europe GmbH, Duesseldorf (DE)

(21) Appl. No.: 17/199,517

(22) Filed: Mar. 12, 2021

(30) Foreign Application Priority Data
Apr. 22, 2020 (EP) 20170835.1

(51) Int. Cl. G01N 21/79; G01N 1/14; G01N 1/38; G06T 7/90; B08B 3/10; G06F 16/53

(52) U.S. Cl. CPC G01N 21/79; G01N 1/14; G01N 1/38; G06T 2207/10024; B08B 3/10; G06F 16/53; G01N 2201/062; G06T 7/90

(57) ABSTRACT

An apparatus and a method for determination of fluid-specific parameters and/or components of a sample uses a titration unit, an indicator, a reagent, and a measurement chamber. The apparatus has an RGB camera arranged outside of the measurement chamber, wherein the data recorded by this RGB camera can be transmitted to a computer unit and the image data transmitted to the computer unit in this connection can be compared using this computer unit with a reference database, preferably including an image and color database, and evaluated, so that action instructions can be output automatically, preferably by way of a speech module. In this way, fluid-specific parameters and/or components of a sample can be determined in automated manner, and action instructions can be output or carried out automatically.

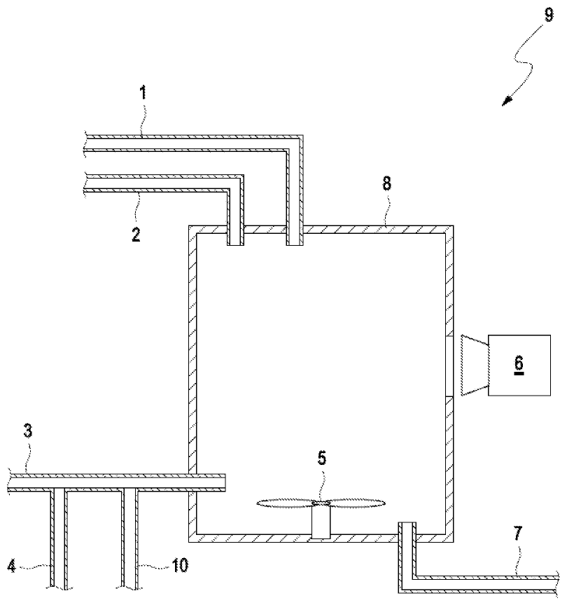

### CROSS REFERENCE TO RELATED APPLICATIONS

Applicant claims priority under 35 U.S.C. § 119 of European Application No. 20170835.1 filed Apr. 22, 2020, the disclosure of which is incorporated by reference.

### BACKGROUND OF THE INVENTION

### 1. Field of the Invention

The invention relates to an apparatus as well as to a method for determination of fluid-specific parameters and/or components of a sample, using a titration unit, an indicator, a reagent, and a measuring chamber.

### 2. Description of the Related Art

From the prior art, the German patent DE 10 2005 027 590 A1 is previously known, among other things, which discloses an automated process analysis device with optical color detection. This device functions in accordance with the principle of a titrator or of a photometer and can analyze ingredients of water. The automated process analysis device is characterized in that during titration of a measured water sample, detection of the transition point takes place by optical color detection, using a determination reagent specifically coordinated with the measurement task, and with determination of the measurement value. The measurement values obtained in this manner are determined and evaluated by means of a microprocessor, wherein in this way, control and regulation of process technology processes are made possible.

Furthermore, an apparatus for regulation of the components of a separation solution in a separation bath is known from EP 0 043 893 B1. This apparatus comprises a sensor hanging in the bath, which sensor responds to the concentration of one or more of the components in the solution and can generate a signal, whereby a pump introduces a refill solution into the bath, so as to balance out the missing components within the bath, in each instance.

Furthermore, from US 2013/0217134 an apparatus for monitoring a coating material solution is known, which is checked using a titration method. In this regard, during the titration method a volume of the coating solution is brought into contact with a reagent solution, to form a mixture, wherein for determination of the color change, a color processing apparatus is used during titration, so as to be able to determine the end point of the titration.

CN 102103089 A also discloses an end-point-determining titration apparatus for determination of the concentration of fatty acids in grain.

In the publication by Lima et al. (Ricardo Alexandre C. Lima, Luciano F. Almeida, Wellington S. Lyra, Lucas A. Siqueira, Edvaldo N. Gailāo, Sérgio S. L. Paiva Junior, Rafaela L. F. C. Lima, Digital movie-based on automatic titrations, Talanta, Volume 147, 2016, Pages 226-232, ISSN 0039-9140), the use of a webcam for detection of the color progression within a titration process is disclosed. In this regard, the color progression during automated titration is detected and evaluated by means of the individual image frames recorded by the webcam.

U.S. Pat. No. 8,236,564 B2 discloses an apparatus for determination of parameters and of the compatibility of a substance, for example asphalt or another petroleum-based substance, wherein titration is used for precise determination of one or more flocculation possibilities, which is particularly suitable for the determination of Heithaus parameters and the optimal mixture of various asphalt materials.

US 2004/0023405 A1 also discloses a method and an apparatus for continuous titration, in which at least one parameter of at least one compound in a mixture can be monitored, while the composition of the mixture is continuously varied.

### SUMMARY OF THE INVENTION

Proceeding from this state of the art, the invention is based on the task of making available an apparatus as well as a method with which fluid-specific parameters and/or components of a sample can be determined in automated manner, and action instructions can be output or carried out automatically. This task is accomplished by means of an apparatus according to one aspect of the invention and a method according to another aspect of the invention. Further advantageous embodiments are discussed below.

According to the invention, an apparatus is provided for determination of fluid-specific parameters and/or components of a solution, comprising a sample of a solution to be determined, a titration unit, an indicator, and a reagent complementary to the indicator and the parameter or component to be determined. This sample, preferably a sample of a solution of a cleaning bath, which can, in particular, contain dissolved components, can be homogeneously mixed by means of a stirrer, in this regard. By means of a titration unit known from the state of the art, an indicator and/or a reagent can be added to this homogeneously stirred solution, so that as a function of the solvent used, the fluid-specific parameters, and the individual dissolved components of the sample, a characteristic color occurs within the sample solution.

The invention is characterized in that this color or color change can subsequently be detected using a red-green-blue (RGB) camera arranged outside of the measurement chamber. The data determined by means of the RGB camera, particularly in the form of images, can subsequently be passed on to a computer unit in which these data are then compared with a reference database and can be evaluated accordingly. In this way, in particular, solution components, the purity of solutions or solvents, and further fluid-specific parameters can be determined. Ultimately, based on the evaluation that has been carried out, action instructions can be issued. These action instructions can be, in particular, instructions for adding solution components for stabilization of a solution or of a solution bath, replacement of the solution—because contaminants, for example decomposition products, were determined—as well as output of a measurement protocol. Preferably, these measures can be initiated or carried out automatically, based on the action instructions output by the apparatus.

In an advantageous embodiment, the apparatus can have a sampling location for a sample of a solution, in particular a sample of a solution of a cleaning bath, and/or a filter and/or a valve and/or a pump, so that a sample to be determined can be introduced into the measurement chamber in filtered manner, in particular. In this way, a sample can be introduced into the measurement chamber of the apparatus in fully automated manner, and accordingly, the components and/or fluid-specific parameters to be determined can be determined automatically.

Particularly preferably, the apparatus can have a feed line for a sample, so that this sample can be introduced directly into the measurement chamber. Preferably, in this regard, this access can have a filter, a valve, as well as a pump, with which the sample can be introduced into the measurement chamber in automated manner, in filtered manner, and in a volume that can be adjusted in advance by the pump.

In a particularly preferred embodiment, the apparatus can have a sampling unit at this access for a sample, with which unit a sample can be taken from an evacuated region and brought to normal pressure within the sampling unit, without having to interrupt the vacuum of the region from which the sample was taken. As a result, the apparatus can also be connected with systems under vacuum, and samples can be taken from such a system accordingly.

In order to prevent possible contamination of the measurement chamber, the sampling unit can have a sensor for detection of clouding of a sample that was taken. In this way, contaminants in the form of particles or other contaminants, for example, can be determined before they get into the measurement chamber when the sample is introduced into it, which would then make cleaning, generally complicated cleaning of the measurement chamber necessary, wherein this contamination can be counteracted by means of the use of the aforementioned sensor for detection of possible clouding.

In a further advantageous embodiment, the apparatus can have a feed line with a valve, so that a flushing fluid can be introduced into the measurement chamber by means of a pump, in particular a hose pump. In this way, it can be ensured after a measurement is carried out or that after a sample is introduced into the measurement chamber, the latter can be cleaned without residues, by flushing it with a flushing fluid, and thereby possible contamination of a sample to be introduced subsequently can be counteracted.

Also, the apparatus can have a drain line on the measurement chamber, with which the solution contained in the measurement chamber, in particular a flushing solution, can be drained off. This arrangement is advantageous if automated determination of the components of the sample solution is to be carried out repeatedly, because after a successful analysis the measurement chamber must be cleaned so as to remove possible residues within the measurement chamber and, in this way, so as to minimize or exclude measurement errors or measurement imprecision during the next determination. By means of inflow and outflow, an automated flushing cycle between the measurements can therefore be implemented. Also, solvent-appropriate disposal can thereby also be guaranteed.

In order to dilute the sample for determination of the fluid-specific parameters and/or of the components of a sample to the concentration desired for the determination, i.e. to put them into solution, the apparatus has a feed line, with a valve, to the measurement chamber, so that after feed of a sample to be determined, the sample can be mixed with at least one solvent. In this way, single-phase or multi-phase systems can be produced, in which, depending on the sample to be investigated, different fluid-specific parameters occur in the respective phases, or different components of the sample are dissolved in the different phases, in each instance.

This production of such systems is particularly the case if the components are not soluble in water, for example, but can be dissolved in organic solvents and therefore, depending on the solvents used, both an aqueous phase and an organic phase can form, and thereby liquid-liquid extraction can be carried out within the measurement chamber.

In an advantageous embodiment, the pumps can be implemented in the form of micro-metering pumps, with which preferably a minimum volume of up to 5 μL can be conveyed. Thereby precise addition of at least one solvent or the addition of a defined amount of an indicator and/or of a reagent can be made possible, and in the end result, the precision of the determination is increased by evaluation of the data recorded by the RGB camera.

In order to increase or adapt the intensity of the color that occurs or of the color change, the apparatus can have a light source in the direction of the RGB camera, which source emits parallel light. In a preferred embodiment, the light source can be positioned in front of the measurement chamber in such a manner that the focal point of the incident parallel light is at the level of the RGB camera. In this way, it can be ensured that all the light emitted by the solution is detected by the RGB camera.

Preferably, in this regard, the light source can be composed of at least one LED, wherein particularly preferably, the light sources are arranged at a regular distance from one another, preferably of 5 mm, in each instance.

In a further advantageous embodiment, the apparatus can have a magnetic stirrer and/or a shaker, so that the solution can be homogeneously mixed within the measurement chamber. In this regard, the magnetic stirrer can move a magnetic agitator arranged within the measurement chamber, so that homogeneous mixing of the solution can be guaranteed. The magnetic agitator furthermore has the advantage that it can be easily removed from the measurement chamber and replaced, if necessary. Also, a shaker can be arranged on the measurement chamber, wherein homogeneous mixing of the solution is also guaranteed by means of the jogging or shaking movement of the shaker. In comparison with the magnetic stirrer, the shaker has the advantage that no further parts need to be present within the measurement chamber, on which residues could deposit and therefore make cleaning of the measurement chamber more difficult.

In order to make it possible to use the apparatus also for combustible solutions, in particular easily flammable solvents that frequently also have a low vapor pressure, as well as for water-polluting solvents, in particular for fluorinated solvents, for example perchloroethylene or trichloroethylene, the apparatus can consist of solvent-resistant materials, in particular of glass, steel, steel alloys or plastic, which are suitable both for organic solvents and for aqueous solutions, in particular for acidic or basic solutions.

In a preferred embodiment, the apparatus can be integrated directly into a facility, in particular into a cleaning bath, a cleaning facility or a steam degreasing facility. In this way, fully automated sampling, sample measurement and disposal of the materials used during the analysis that is conducted can be guaranteed, without having to manually remove a sample from the facility during this process, wherein in the state of the art, this sampling measurement and disposal was previously generally connected with having to stop a running facility for a short time, so as to be able to remove the corresponding sample from the facility. This interruption becomes obsolete as the result of integration of the apparatus into an existing facility system, and regular monitoring of the quality of the solvents used within the facility and of their dissolved components can be guaranteed without making corresponding interruption of the operation of the facility necessary in this regard.

In a further embodiment, the apparatus has a display on which data determined as the result of measurement of the components of a sample, in particular, or even concrete action instructions can be displayed, for example whether, which ones and how many stabilizers should be added to a cleaning bath from which the sample was taken, so as to stabilize this cleaning bath. Also, action instructions can be issued to the apparatus by way of the display itself; in particular, the cleaning process of the measurement chamber of the apparatus can be carried out manually by means of the display. This feature has the advantage that intervention by a user can continue to be guaranteed, even in the case of complete automation of the apparatus. In this regard, in an even further improved embodiment, the recorded data and/or the evaluated data are queried and processed further, in hard-wired and/or wireless manner, by way of a network.

Furthermore, the invention makes a method available with which the fluid-specific parameters and/or the components of a sample can be determined using an apparatus as described above. This method is characterized in that an indicator coordinated with the components or fluid-specific parameters to be investigated is added to a sample by means of a titration unit. By means of addition of the indicator to the solution present within the measurement chamber, a color occurs, which can be recorded by means of the RGB camera.

After the characteristic coloring occurs as the result of adding the indicator, a reagent coordinated with the indicator and with the component of the sample to be determined or the fluid-specific parameters to be determined is also added by means of the titration unit, and the color change that occurs within the sample solution in this regard, due to addition of the reagent, is detected by means of the RGB camera. The data obtained by the RGB camera in this manner are subsequently transmitted to a reference database and compared with the latter, so that based on the evaluation, in other words the comparison of the measured data with the data in the reference database, action instructions can be issued, possibly automatically using a speech module.

In an advantageous embodiment, the sample is mixed with at least one solvent coordinated with the components to be investigated or the fluid-specific parameters, with the indicator used as well as the reagent used. In this regard, multiple different solvents can also be used, so that multiple phases also form within the measurement chamber, wherein different dissolved components or fluid-specific parameters, which can each be detected separately, are certainly present in these different phases.

In a preferred embodiment, the addition is checked by means of reconciliation of the volume conveyed by means of a pump, and of the at least one solvent, with the fill level within the measurement chamber determined by means of the RGB camera. In this way it can be ensured, by means of the redundant check, that the amount of the at least one solvent conveyed by the pump, preferably a micro-metering pump, does in fact correspond to the amount actually to be conveyed.

In a further advantageous embodiment of the method, in the case of multi-phase systems, after addition of an indicator and/or a reagent coordinated with the components to be determined or the fluid-specific parameters to be determined, the phases can be thoroughly mixed by means of a stirrer, for a period of time coordinated with the solvents that are present and with the indicator that is added and/or with a reagent that is to be added. After the multi-phase system has been thoroughly mixed by the stirrer for a specific period of time, stirring is stopped for a specific period of time, so that no mixing takes place, but rather the phases can once again form completely. In this way, it can be ensured that even in the case of multi-phase systems, homogeneous distribution of the components to be investigated or of the fluid-specific parameters and/or complete dissolution of the components to be investigated or of fluid-specific parameters of the sample is guaranteed when using more than one solvent.

Preferably, the determination of the data needed for the evaluation is carried out by means of the RGB camera after termination of the mixing process carried out by a stirrer. In this regard, after addition of an indicator coordinated with the components to be determined and/or a reagent to the sample solution, thorough mixing of the sample solution takes place, so as to be able to guarantee homogeneous distribution of the indicator to be added and/or the reagent. Finally, the color that occurs after addition of the indicator or the color change of the homogeneously mixed solution that occurs as the result of addition of the reagent can be detected by the RGB camera.

In a further advantageous embodiment of the method, the solution situated within the measurement chamber is conducted away after determination of the fluid-specific parameters and/or after determination of the components of the sample, and the measurement chamber is flushed with a flushing fluid, so that it can be guaranteed that no residues of the measurement conducted previously are present any longer within the measurement chamber; such residues could lead to an incorrect analysis of the subsequent measurement.

So that it can be guaranteed after flushing of the measurement chamber with a flushing fluid that no residues are present any longer in the measurement chamber, in an advantageous embodiment a fluid, in particular a sample or some other fluid can be introduced into the measurement chamber, and a zero point determination can be conducted with it. If it were to be found during this zero point determination that the measurement chamber was not cleaned completely without residues, then the chamber is flushed with a flushing fluid once again, and a zero point is carried out once more, and this process is repeated until no residues are present in the measurement chamber any longer.

In order to carry out calibration or adjustment of the apparatus, a reference solution can be introduced into the measurement chamber after flushing of the measurement chamber, wherein this reference solution contains predefined components or fluid-specific parameters, so as to be able to carry out adjustment or calibration of the apparatus using this solution. In this way, it can be ensured that the measured data of the samples to be investigated correspond to the actual parameters.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

The sole FIGURE shows a cross-section of a schematic representation of an exemplary embodiment in a side view.

### DETAILED DESCRIPTION OF PREFERRED EMBODIMENTS

The sole FIGURE shows a cross-section of a schematic representation of an exemplary embodiment of an apparatus 9 in a side view.

In this regard, the apparatus 9 shown in the sole FIGURE has a measurement chamber 8, wherein a stirrer 5 connected with the measurement chamber 8 is arranged on the lower bottom of the measurement chamber 8. A sample, which was previously taken from a cleaning bath, for example, can be introduced into the measurement chamber 8 by way of the sampling line 3. Subsequently, after introduction of the sample into the measurement chamber 8 by way of the sampling line 3, the sample can be diluted to the desired solution amount within the measurement chamber 8, using a dilution solution from the dilution line 10. After corresponding dilution, an indicator that is appropriate for the components within the sample solution that are to be investigated can be added to the solution by means of the indicator line 2 of a titration unit. In order to always guarantee homogeneous mixing of the sample solution to be investigated, in particular after addition of an indicator by way of the indicator line 2, the solution is stirred continuously or, in the case of multi-phase systems, at intervals by means of the stirrer 5 arranged at the bottom within the measurement chamber 8.

Following addition of the indicator, the color of the solution is detected by means of an RGB camera 6 arranged outside of the measurement chamber 8, wherein after every addition of a reagent suitably coordinated with the components of the sample solution to be investigated, by way of the reagent line 1, to the homogeneously mixed solution, the data, in each instance, in particular in the form of an image, of the solution that changes color are recorded by means of the RGB camera 6.

The data obtained in this manner, particularly images, are subsequently transmitted by the RGB camera 6 to a computer unit not shown in any detail here, within which the recorded data are compared with reference data, so that based on the evaluation of the recorded data with the reference data, action instructions are output by the apparatus 9, for example by means of a display not shown in any detail here, or carried out automatically by the apparatus 9, for example by means of addition of stabilizers to the cleaning bath from which the sample was previously taken.

After completion of the measurement, the sample solution, consisting of the solvent used for dilution, the sample mixed with the solvent, the added indicator and the added reagent can be conducted out of the measurement chamber 8 through an outlet line 7.

In order to remove possible residues of the sample solution from the measurement chamber 8 and to thereby prevent contamination of a further measurement that follows the first measurement, not only the sampling line 3 but also the dilution line 10 and the measurement chamber 8 as such can be flushed and thereby cleaned by means of the flushing fluid line 4, wherein the flushing fluid can also be conducted away from the measurement chamber 8 by way of the outlet line 7.

After successful flushing of the measurement chamber 8, the sampling line 3, and the dilution line 10, the apparatus 9 is ready for renewed measurement of a sample.

Thereby an apparatus has been disclosed above, with which fluid-specific parameters and/or components of a sample can be determined in automated manner, and action instructions can be output or preferably carried out automatically.

Although only a few embodiments of the present invention have been shown and described, it is to be understood that many changes and modifications may be made thereunto without departing from the spirit and scope of the invention.

What is claimed is:

1. An apparatus for determination of fluid-specific parameters or components of a sample comprising:
(1) a titration unit;
(b) a measurement chamber comprising an indicator and a reagent;
(c) an RGB camera arranged outside the measurement chamber;
(d) a computer unit; and
(e) a reference database;
wherein the RGB camera is configured to record data comprising image data and to transmit the image data to the computer unit;
wherein the computer is configured to compare the image data with the reference database and to evaluate the image data; and
wherein the computer is configured to cause to be output automatically action instructions based on the image data compared with the reference database and evaluated.

2. The apparatus according to claim 1, wherein the measurement chamber has an access for the sample.

3. The apparatus according to claim 2, wherein the access has at least one of a filter, a valve, and a pump configured to introduce the sample into the measurement chamber.

4. The apparatus according to claim 2, wherein the access has a sampling unit configured to take the sample from an evacuated region having a vacuum and to bring the sample to normal pressure within the sampling unit, without interrupting the vacuum of the evacuated region.

5. The apparatus according to claim 4, wherein the sampling unit has a sensor for detection of clouding of the sample.

6. The apparatus according to claim 2, further comprising a pump and a feed line configured to introduce a flushing fluid into the measurement chamber using the pump.

7. The apparatus according to claim 1, wherein the measurement chamber has a drain line configured to conduct away a solution contained in the measurement chamber.

8. The apparatus according to claim 1, further comprising a feed line to the measurement chamber configured to feed at least one solvent into the measurement chamber for mixing with the sample to be determined after feed of the sample into the measurement chamber.

9. The apparatus according to claim 6, wherein the access has a pump and the pump in the access and the pump in the feed line are micro-metering pumps.

10. The apparatus according to claim 1, further comprising a light source that emits parallel light into the measurement chamber toward the RGB camera.

11. The apparatus according to claim 10, wherein the light source is positioned in front of the measurement chamber in such a manner that a focal point of the light radiated into the measurement chamber is level with the RGB camera.

12. The apparatus according to claim 10, wherein the light source comprises at least one LED.

13. The apparatus according to claim 10, wherein the light source comprises a plurality of LEDs arranged at a uniform distance from one another.

14. The apparatus according to claim 1, further comprising at least one of a magnetic stirrer and a shaker.

15. The apparatus according to claim 1, wherein the measurement chamber is made from solvent-resistant materials.

16. The apparatus according to claim 1, wherein the apparatus is integrated into a cleaning bath, a cleaning facility or a steam degreasing facility.

17. The apparatus according to claim 1, further comprising a display configured to display the action instructions or to input commands.

18. The apparatus according to claim 1, wherein the computer unit is configured to retrieve based on commands communicated to the computer in hard-wired manner or wirelessly the image data compared with the reference database and evaluated.

19. A method for determination of fluid-specific parameters or components of a sample comprising:
(a) providing an apparatus comprising a titration unit, a measurement chamber, an RGB camera arranged outside the measurement chamber, a computer unit, and a reference database, wherein the RGB camera is configured to record data comprising image data and to transmit the image data to the computer unit, wherein the computer is configured to compare the image data with the reference database and to evaluate the image data, and wherein the computer is configured to cause to be output automatically action instructions based on the image data compared with the reference database and evaluated;
(b) adding an indicator coordinated with the fluid-specific parameters or the components to the sample using the titration unit to cause a color to occur;
(c) detecting the color using the RGB camera;
(d) adding a reagent coordinated with the indicator and with the components of the sample or the fluid-specific parameters to cause a color change to occur;
(e) detecting the color change using the RGB camera;
(f) recording as data the color and the color change detected using the RGB camera;
(g) comparing the data with the reference database; and
(h) outputting instructions based on the data compared with the reference database.

20. The method according to claim 19, further comprising mixing the sample with an amount of at least one solvent coordinated with the components to be investigated, the indicator used, and the reagent used.

21. The method according to claim 20, further comprising checking the amount of the at least one solvent added by reconciling a volume of the at least one solvent conveyed by a pump with a fill level within the measurement chamber determined using the RGB camera.

22. The method according to claim 19, further comprising
adding an indicator coordinated with at least one of the components to be determined and the reagent to cause a system with a plurality of phases to occur;
mixing the phases using a stirrer for a first period of time coordinated with the at least one solvent and the indicator or the reagent; and
halting mixing after the first period of time for a second period of time so that the phases form completely once again.

23. The method according to claim 19, further comprising
mixing a solution of the indicator and the sample before the color that occurs as the result of addition of the indicator is detected by the RGB camera or
mixing a solution of the indicator, the sample, and the reagent before the color change that occurs as the result of addition of the reagent is detected by the RGB camera.

24. The method according to claim 19, further comprising
conducting away a solution situated within the measurement chamber after determination of the fluid-specific parameters or the components; and
flushing the measurement chamber with a flushing fluid.

25. The method according to claim 24, further comprising carrying out a zero point determination by introducing a fluid into the measurement chamber after flushing of the measurement chamber.

26. The method according to claim 19, further comprising
introducing a reference solution into the measurement chamber; and
adjusting or calibrating the apparatus based on the fluid-specific parameters or the components of the reference solution.
